(19) United States
(12) Patent Application Publication
(10) Pub. No.: US 2023/0069342 A1
(43) Pub. Date: Mar. 2, 2023

(54) COMPUTER SYSTEM AND METHOD OF DETERMINING MODEL SWITCH TIMING

(71) Applicant: Hitachi, Ltd., Tokyo (JP)

(72) Inventors: Keita Mizushina, Tokyo (JP); Satoshi Katsunuma, Tokyo (JP); Keiro Muro, Tokyo (JP)

(73) Assignee: Hitachi, Ltd., Tokyo (JP)

(21) Appl. No.: 17/675,485

(22) Filed: Feb. 18, 2022

(30) Foreign Application Priority Data
Aug. 27, 2021 (JP) 2021-139176

(51) Int. Cl. G06F 11/07; G06N 20/00

(52) U.S. Cl. CPC G06F 11/076; G06N 20/00

(57) ABSTRACT

A computer system that detects an abnormality based on time series data, including: an abnormality diagnosis unit that diagnoses an abnormality of the time series data from a machine learning model created based on learning data; a model degradation detection unit that detects degradation in the machine learning model; a learning curve estimation unit that estimates a learning curve and predicts a number of errors per unit time; a model switch cost calculation unit that calculates a number of errors per unit time of a model in operation, a number of errors per unit time of a switch candidate model, a first total cost and a second total cost; and a model switch time prediction unit that compares the first total cost with the second total cost to calculate switch time of a machine learning model.

### BACKGROUND

The present invention relates to the operation of a machine learning model, and to the technology of model update determination that determines when a client has to update a learning model.

The states of devices in factories and plants change over time due to environmental changes, long-term deterioration, changes in manufactured products or operators, and the like. Consequently, machine learning modes applied for the purpose of predictive maintenance and the like have to be continuously trained following changes.

Here, in the case in which a client operates a system that uninterruptedly continues learning using latest data, the client has to determine the update of a model following changes. The following is conventional technologies relating to the evaluation or selection of models.

For example, in US2018/0366124, a processor-implemented method for training of a text independent (TI) speaker recognition model, the method includes: measuring, by a processor-based system, context data associated with collected TI speech utterances from a user in a context, the collected TI speech collected during a first time interval; identifying, by the processor-based system, an identity of the user based on received identity measurements; performing, by the processor-based system, a speech quality analysis of the TI speech utterances; performing, by the processor-based system, a state analysis of the user based on the TI speech utterances; evaluating, by the processor-based system, a training merit value associated with the TI speech utterances, based on the speech quality analysis and the state analysis; and storing, by the processor-based system, the TI speech utterances as training data in a training database, if the training merit value exceeds a threshold value, the stored utterances indexed by the user identity and the context data.

Japanese Unexamined Patent Application Publication No. 2018-005855 discloses a reception unit that receives, from a target device, context information corresponding to a present operation in a plurality of pieces of context information determined for every type of the operation of the target device and detection information from a detection unit that detects a physical quantity changing corresponding to the operation of the target device; a determination unit that determines whether the operation of the target device is normal using the detection information received by the reception unit and a plurality of models corresponding to the context information received by the reception unit in one or more models corresponding to one or more models corresponding to one or more pieces of the context information; and a display control unit that displays individual determined results determined by the determination unit on a display unit when using a plurality of models.

### SUMMARY

Since the update of a model in manufacturing industries such and the like cause various costs, it is necessary to determine the update of a model at appropriate timing in consideration of cost.

However, US2018/0366124 and Japanese Unexamined Patent Application Publication No. 2018-005855 do not refer to the occurrence of cost necessary for the update of a model such as the confirmation of the operation of a model or creating documents.

It is an object of the present invention is to assist determination of the model update time in consideration of cost for the update of a model.

A preferable aspect of the present invention is a computer system that detects an abnormality based on time series data the system including: an abnormality diagnosis unit that diagnoses an abnormality of the time series data from a machine learning model created based on learning data; a model degradation detection unit that detects degradation in the machine learning model; a learning curve estimation unit that estimates a learning curve of the machine learning model and predicts a number of errors per unit time using the learning curve; a model switch cost calculation unit that calculates a number of errors per the unit time of a model in operation that is a machine learning model presently being used, a number of errors per the unit time of a switch candidate model that is a switch candidate of a model in operation, a first total cost when a machine learning model is switched at given first time based on error cost information that defines a cost per error, and a second total cost when a machine learning model is switched at given second time; and a model switch time prediction unit that compares the first total cost with the second total cost to calculate switch time of a machine learning model.

Another preferable aspect of the present invention is a method of determining model switch timing including: in a computer system that diagnoses an abnormality of time series data from a machine learning model created based on learning data, when timing of switching of the machine learning model is determined, a model degradation detecting step of detecting degradation in the machine learning model; a learning curve estimation step of estimating a learning curve of the machine learning model to predict a number of errors per unit time using the learning curve; a model switch cost calculating step of calculating a number of errors per the unit time of a model in operation that is a machine learning model presently being used, a number of errors per the unit time of a switch candidate model that is a switch candidate of a model in operation, a first total cost when a machine learning model is switched at given first time based on error cost information that defines a cost per error, and a second total cost when a machine learning model is switched at given second time; and a model switch time predicting step of comparing the first total cost with the second total cost to calculate switch time of a machine learning model.

It is possible to assist determination of the model update time in consideration of cost for the update of a model.

### BRIEF DESCRIPTION OF THE DRAWINGS

FIG. 1 is a functional block diagram according to a first embodiment;

FIG. 2 is a functional block diagram showing the input-output relationship of information between modules according to the first embodiment;

FIG. 3 is a table showing time series data collected from a fabrication apparatus that is a target according to the first embodiment;

FIG. 4 is a table showing device context information according to the first embodiment;

FIG. 5 is a table showing model switch cos information according to the first embodiment;

FIG. 6 is a table showing cost information when an erroneous report and a false report occur according to the first embodiment;

FIG. 7 is a graph describing a process for estimating the learning curve of a switch candidate model more in detail according to the first embodiment;

FIG. 8 is a graph describing a process for deciding model update time using the number of erroneous reports and false reports per unit time more in detail according to the first embodiment;

FIG. 9 is a graph describing a process when model switch determination is performed in an early stage more in detail according to the first embodiment;

FIG. 10 is a graph describing a process when model switch determination is performed at appropriate time more in detail according to the first embodiment;

FIG. 11 is a flowchart showing the process procedures of an abnormality diagnosis unit according to the first embodiment;

FIG. 12 is a flowchart showing the process procedures of a model update determination unit according to the first embodiment;

FIG. 13 is a graph describing a process when context information is used more in detail according to a second embodiment;

FIG. 14 is a table showing context information according to the second embodiment;

FIG. 15 is a flowchart showing the process procedures of a learning curve estimation unit according to the second embodiment;

FIG. 16 is a functional block diagram according to the third embodiment;

FIG. 17 is a functional block diagram showing the input-output relationship of information between modules according to a third embodiment;

FIG. 18 is a conceptual diagram describing a process for creating a learning curve prediction model using a past model learning curve more in detail according to the third embodiment; and

FIG. 19 is a flowchart showing the process procedures of learning curve estimation according to the third embodiment.

### DETAILED DESCRIPTION

Referring to the drawings, embodiments will be described in detail. However, the present invention should not be interpreted limited to the content described in embodiments shown below. A person skilled in the art will easily understand that the specific configurations of the present invention can be modified within the scope not deviating from the idea and gist of the present invention.

In the configurations of the embodiments described below, the same parts or parts having similar functions have the same reference signs common in the drawings, and their duplicate description is sometimes omitted.

In the case in which there are pluralities of the same elements or elements having similar functions, description is sometimes made with different subscripts added to the same reference signs. However, in the case in which it is unnecessary to distinguish between a plurality of elements, description is sometimes made with subscripts omitted.

The notations “first”, “second”, “third”, and the like in the present specification and the like, are added to identify components, which do not necessarily limit numbers, orders, or their contents. The numbers that identify components are used for each context, and the number used for one context does not necessarily show the same configuration on another context. The component identified by a certain number is not prevented from serving as the function of the component identified by another number.

In order to easily understand the invention, in regard to the positions, sizes, shapes, ranges, and the like of the configurations shown in the drawings, the actual positions, sizes, shapes, ranges, and the like are not sometimes shown. Therefore, the present invention is not necessarily limited to the positions, sizes, shapes, ranges, and the like disclosed in the drawings.

Publications, patens, and patent applications cited in the present specification constitute a part of the description of the present specification.

A component described in a singular form in the present specification includes a plural form unless otherwise specified in the context.

An example of an embodiment described below is a method of operating a machine learning model that monitors the state of a device or a plant, the method having an abnormality diagnosis unit that determines an abnormality of a device based on time series data stored in a storage; and a determination unit for the update of a model, the determination unit that calculates the number of erroneous reports and false reports in the case in which the model is switched at a given date and time t based on context information and model switch cost information stored in the storage, that calculates a total of a cost produced from the erroneous report and the false report and a cost of model switch, and that switches the model at date and time T at which the total of costs is minimum. According to this embodiment, it is possible to perform model switch at the date and time T at which the total of costs is minimum based on the cost produced from the erroneous report and the false report in the case in which the update of the model is performed at the given time t and the cost necessary for model switch.

### First Embodiment

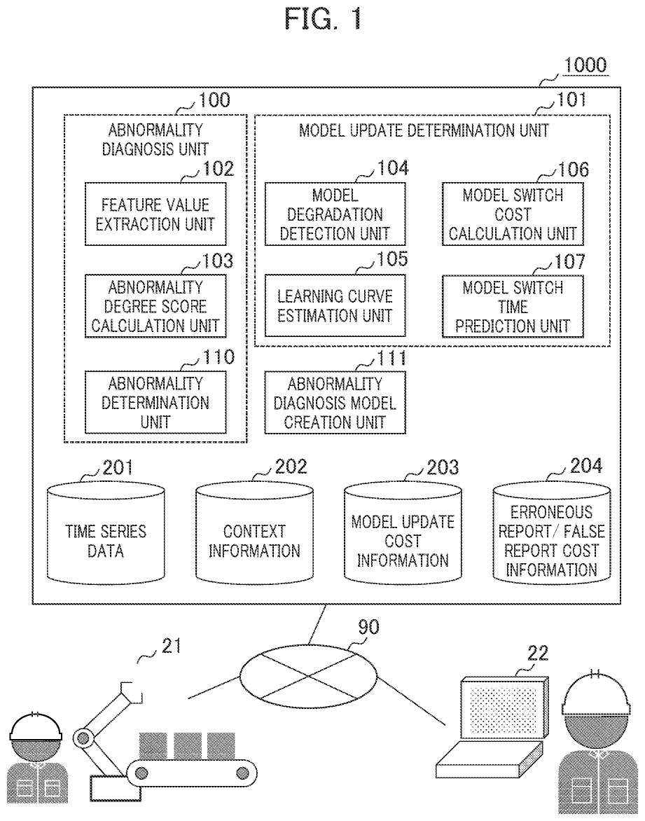

FIG. 1 shows an exemplary configuration that implements an embodiment of the present invention. As shown in FIG. 1, a computer system 1000 is configured broadly including an abnormality diagnosis unit 100 and a model update determination unit 101.

The abnormality diagnosis unit 100 includes a feature value extraction unit 102 that receives sensor data in a time series output from a facility to extract a feature value, an abnormality degree score calculation unit 103 that calculates an abnormality degree score with a machine learning model using the feature value extracted by the feature value extraction unit 102, and an abnormality determination unit 110 that compares the abnormality degree score with an abnormality determination threshold decided beforehand to determine an abnormality. For the abnormality diagnosis unit 100, an abnormality determination system using conventional machine learning can be basically adopted.

The model update determination unit 101 is configured including a model degradation detection unit 104 that detects degradation in a model from the tendency of a change in the abnormality degree score output from the abnormality degree score calculation unit 103, a learning curve estimation unit 105 that determines the sufficiency of the amount of learning data necessary for training a machine learning model at a time point of detecting degradation in the model by the model degradation detection unit 104, a model switch cost calculation unit 106 that calculates a cost produced in the case of receiving the output of the learning curve estimation unit 105 to switch the model at given time t, a model switch time prediction unit 107 that receives the outputs of the learning curve estimation unit 105 and the model switch cost calculation unit 106 to predict appropriate model switch time T, and an abnormality diagnosis model creation unit 111.

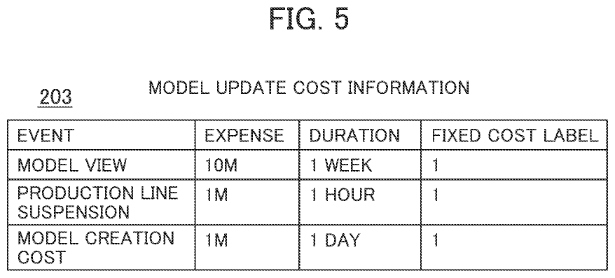

In US2018/0366124, a speaker recognition model has been created in consideration of the sufficiency of data (FIG. 5 in US2018/0366124). In Japanese Unexamined Patent Application Publication No. 2018-005855, it has been possible to select an appropriate model from two or more models using detection information presently obtained (paragraph 0006 in Japanese Unexamined Patent Application Publication No. 2018-005855). However, these have not considered costs on switching models. The model update determination unit 101 of the present embodiment can suggest the update timing in consideration of switch cost.

As shown in FIG. 1, the computer system 1000 connected to a network 90 can communicate with a terminal 22 that is connected to the computer system 1000 and can communicate with the computer system 1000, and the computer system 1000 can causes the terminal 22 to display the diagnosis result of the abnormality diagnosis unit 100.

The network 90 may be the Internet and a mobile telephone network, and a wireless LAN such as Wi-Fi CERTIFIED (registered trademark) may be interposed. For the terminal 22, a tablet terminal, a smartphone, and the like are preferable, in addition to a personal computer.

other than the computer system 1000 and the terminal 22, a sensor 21 is also connected to the network 90, the sensor 21 being mounted on devices in a factory or a plant having a target device that can communicate with the computer system 1000 and the terminal 22. The sensor 21 transmits various items of measured sensor data in a time series to the computer system 1000 through the network 90 in real time. The sensor 21 may acquire information from a sensor that measures an electric current, a voltage, and the like, an acceleration sensor that detects vibrations, a microphone that collects inspection sounds and the like, and a camera and the like used for image inspection. The sensor 21 acquires sensor data in a time series as well as context information such as changes in the states of various devices on which the sensor is mounted, and the sensor 21 transmits the sensor data and the context information to the computer system 1000 through the network 90 in real time.

The drawing of publicly known hardware configurations constituting the computer system 1000 is substantially omitted. The hardware constituting the computer system is a computer including a processor (processing unit), a main memory, an input device, an output device, an interface (I/F), and a storage device connected to each other. The processor performs a program stored in the main memory.

The main memory (storage) is a semiconductor memory, for example, and stores a program performed by the processor and information that is referred by the processor. Specifically, at least a part of the program and the information stored in the storage device is copied in the main memory, as necessary.

The input device receives an input from a user of the computer system 1000. The input device may include a keyboard, a mouse, and the like, for example. The output device is an image display device, for example, and an example is a liquid crystal display device. An input-output device is included in a personal computer, a tablet terminal, a smartphone, and the like, which are used as the terminal 22.

The storage device is a non-volatile storage device like a hard disk device (HDD) or a flash memory, for example. The storage device stores at least time series data 201, context information 202, model update cost information 203, the erroneous report/false report cost information 204, and past model learning curve 205.

The configuration of the computer system 1000 may be configured of a single computer, or may be configured of another computer having a given part connected via a network.

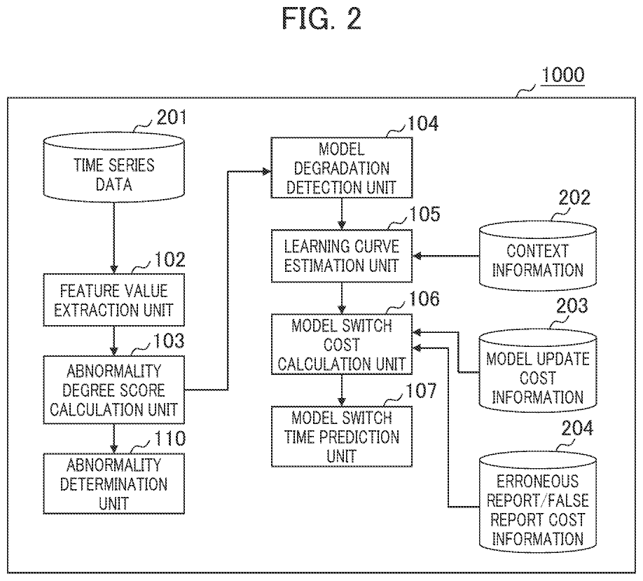

FIG. 2 is a functional block diagram showing the input-output relationship of information between modules according to the first embodiment. FIG. 2 corresponds to FIG. 1, and functions are implemented by the processor performing the program as described in FIG. 1.

As shown in FIG. 2, in the abnormality diagnosis unit 100, the feature value extraction unit 102 extracts a feature value using the time series data 201, the abnormality degree score calculation unit 103 calculates an abnormality degree to input data, and the abnormality determination unit 110 evaluates the calculated abnormality degree to determine an abnormality.

The data of the time series data 201 changes over time due to an environmental factor, a device factor, and a product factor, and the machine learning model of the abnormality determination unit is updated in a certain period. For example, the update of the model in a certain period can cope with the tendency of a medium and long-term change such as aged deterioration in the device. However, for example, in the case in which a sudden change occurs such as the case in which the state of the device is changed, it is not possible to cope with this case with the update of the model in a certain period, and in the case of providing no measures, an erroneous report or a false report occurs in the abnormality determination unit 110.

In order to prevent the erroneous report and the false report from occurring, the model degradation detection unit 104 monitors the tendency of a change in the abnormality degree score continuously or at regular time intervals, and determines that degradation in the model occurs in the case in which the abnormality degree score exceeds a certain threshold. At a time point of detecting degradation in the model by the model degradation detection unit 104, a possibility that the machine learning model of the abnormality determination unit is degraded is merely detected, and neither an erroneous report nor a false report occurs. Here, the degradation in the model means that the machine learning model does not fit to data because the distribution of data changes.

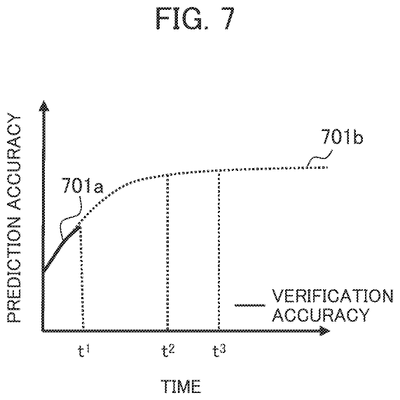

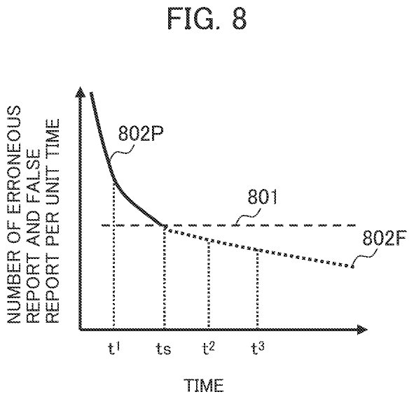

Upon receiving a result of the model degradation detection unit 104, the learning curve estimation unit 105 estimates the data fill rate necessary to create a machine learning model at a time point of detecting degradation in the model. The learning curve estimation unit 105 may evaluate the sufficiency of data necessary to create a machine learning model from the sufficiency of a data volume stored in the time series data 201, the size of data distribution, and the like. An example of the process of the learning curve estimation unit 105 will be described later with reference to FIGS. 7 and 8.

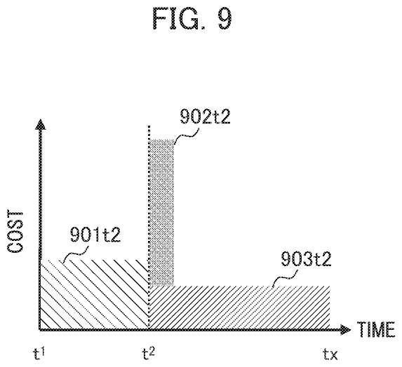

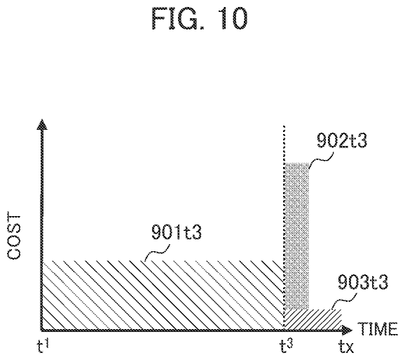

Upon receiving a result of the learning curve estimation unit 105, the model switch cost calculation unit 106 calculates a model switch cost at certain time T using the model update cost information 203. An example of the process of the model switch cost calculation unit 106 will be described later with reference to FIGS. 9 and 10.

Upon receiving a result of the model switch cost calculation unit 106, the model switch time prediction unit 107 predicts time T at which a model switch is made possible at the minimum cost. An example of the process of the model switch time prediction unit 107 will be described later with reference to FIG. 9.

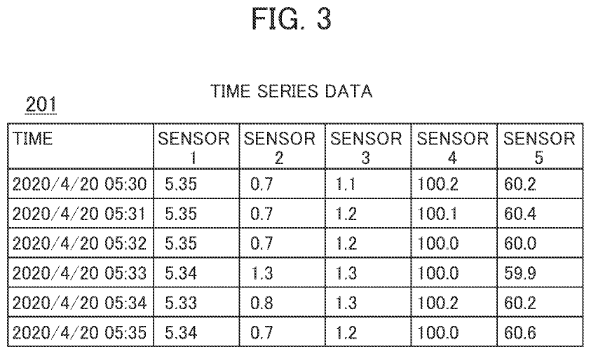

FIG. 3 is an example of the time series data 201 according to the first embodiment. In FIG. 3, sensor data in a time series received from a facility is shown in a table format. The time series data 201, for example, is multi-dimensional sensor data acquired from sensors 1 to 5 mounted on a fabrication apparatus. For the sensor, publicly known various sensors such as optical sensors, sound sensors, vibration sensors, and any other sensors can be used. The sensor data may be the waveform data of speeches collected from a microphone mounted on an inspection apparatus and images of an image sensor mounted in manufacturing process steps.

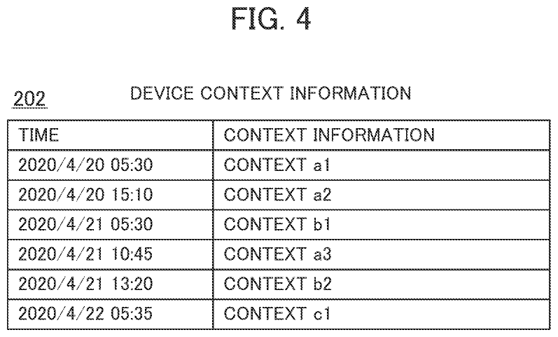

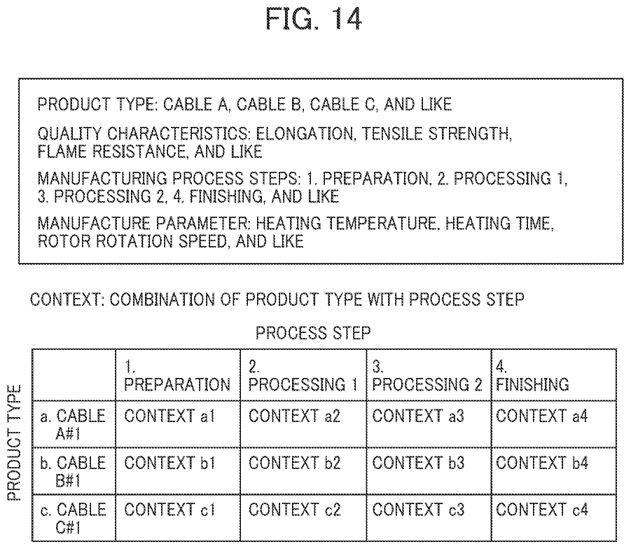

FIG. 4 is a table showing an example of the device context information 202 according to the first embodiment. Here, the context information means information on a device that acquires an input of a model and information describing the situations of a system, and the context information can be freely defined by a user. The context information shown in FIG. 4 shows an example of the context information of the fabrication apparatus. The context information is information that temporally changes, and can include changes in the states of facilities (types, loads, the number of revolutions, and any other parameters), changes in materials that are handled, changes in methods that are performed, changes in the environments of facilities (temperature, humidity, and the like), and any other changes. Such context information can be obtained using the control information and management information of the fabrication apparatus. A specific example of the context information will be described later with reference to FIG. 14.

FIG. 5 is a table showing the model update cost information 203 necessary for model switch according to the first embodiment. The cost means a burden accompanying a predetermined process. Generally, the cost indicates an economical burden, and can be freely defined by the user by expenses or an amount of a temporal burden.

In the case in which an erroneous report and a false report occur during the operation of a device, costs corresponding to these reports occur. However, other than these, model update costs as shown in FIG. 5 occur in the case of performing model switch.

The model update cost information 203 shown in FIG. 5 is prepared beforehand and stored in the storage device. In the example shown in FIG. 5, as “event”, a cost of a model review that verifies the performance of a model before a created model is actually applied to operation, a cost of temporarily stopping production lines to update a model, and a cost of creating a model. The costs above are examples, and can be freely defined by the user based on the user experience of updating models.

In the example shown in FIG. 5, “the expense” and “the duration” of “the events” are defined. As the value of the cost, at least one of the expense and the duration may be used as it is, or the value may be defined as a function using at least one of the expense and the duration.

The model update cost shown in FIG. 5 is a cost produced as a fixed value every time when updating the model. To the fixed cost label, “1” is given to indicate a fixed cost.

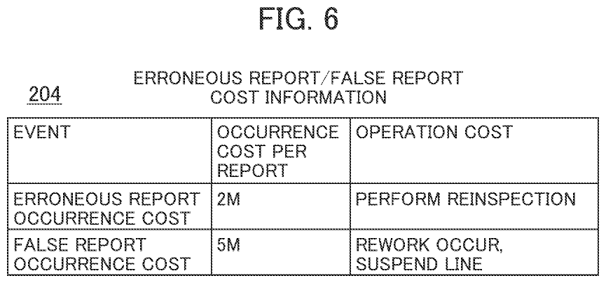

FIG. 6 is a table showing the erroneous report/false report cost information 204 according to the first embodiment. In the case in which an erroneous report occurs, there is a possibility that needs the reinspection of a product determined as abnormal, or in the case in which a false report occurs, there is a possibility that needs the reinspection of a product determined as normal. The costs shown in FIG. 6 are costs that possibly occur per unit time in the case of continuing the operation of a model under the present circumstances.

The erroneous report/false report cost information 204 shown in FIG. 6 is prepared by the user beforehand, and stored in the storage device. FIG. 6 is an example, and can be freely defined by the user based on his/her experience, coping with erroneous reports and false reports. As the value of the cost, a value that the occurrence cost per unit time is multiplexed by operating time may be used as it is, or the value of the cost may be defined as a function using the value.

FIG. 7 is an illustration for explaining the process of the learning curve estimation unit 105 shown in FIGS. 1 and 2, showing a learning curve 701 of the switch candidate model.

The learning curve estimation unit 105 predicts a learning curve from the prediction accuracy of the machine learning model at a time point of detecting degradation in the model by the model degradation detection unit 104 (or time based on a time point of detecting degradation in the model) t1. The learning curve 701 shown in FIG. 7 is a curve that indicates the relationship between the number of samples of learning data and the model prediction performance. The horizontal axis of the learning curve is the number of samples of learning data, and the vertical axis takes a performance index. In the case in which the number of samples correlates with time (e.g., linearly), the horizontal axis may take time as shown in FIG. 7.

The performance index is created using at least one of an index evaluated using learning data and an index evaluated using verification data. A solid line part 701a shown in FIG. 7 indicates an index evaluating a model using verification data, showing that the number of samples of learning data increases over time and the accuracy of evaluation using verification data is improved.

Typically, the performance of the machine learning model can be verified using verification data. In the present embodiment, since it is assumed that a switch is determined together with the numerical value index as well as domain knowledge including the experienced situations and a learning period, and the like, the index evaluated using learning data and period information on learning data are also useful for model switch determination.

The prediction of the learning curve may be based on a data volume using at a time of creating a past model, for example. For example, the solid line part 701a of the learning curve shown in FIG. 7 is actually measured values obtained from the accuracy of a machine learning model created in the past and the number of samples of learning data of the learning model. A dotted line part 701b of the learning curve is prediction values. In order to predict a learning curve from actually measured values, estimation using a machine learning model may be performed.

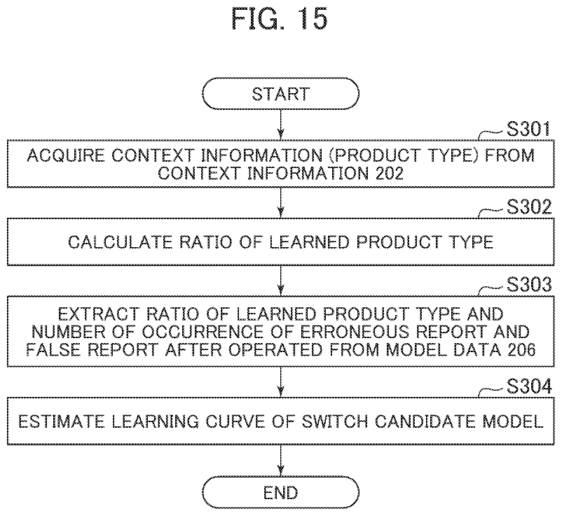

In the case in which device context information is known, the sufficiency of learning data may be determined from context information. The estimation of the learning curve using context information will be described more in detail later in FIG. 15.

FIG. 8 is a diagram more specifically illustrating the process for estimating the number of erroneous reports and false reports per unit time in the learning curve estimation unit 105. As shown in FIG. 7, the verification accuracy is improved with a lapse of time. Consequently, as shown in a curve 802 indicating the characteristic of a switch candidate model in FIG. 8, the number of erroneous reports and false reports per unit time decreases with a lapse of time. A solid line 802P indicates the actually measured value of the characteristic of a trained switch candidate model, and a broken line 802F indicates the characteristic predicted from the actually measured value. Note that the number of erroneous reports and the number of false reports are specific examples, and the number of errors only has to be estimated as errors resulting in cost due to the occurrence of these reports are freely defined.

The number of erroneous reports and false reports per unit time is calculated with expression 1 below, for example, using verification accuracy. The number of erroneous reports and false reports per unit time may be calculated using the context information 202.

the number of erroneous reports and false reports per unit time=(1−the verification accuracy)×the number of inputs of time series data per unit time (expression 1)

Here, the characteristic of the model in operation is indicated by a broken line 801. The model in operation means a model trained in the past and a model presently being used. Here, a premise is that the data distribution is constant and the characteristic 801 of the model in operation is constant. The switch candidate model is a model being trained in background and trained with the latest data in a predetermined period. An object of the present embodiment is to suggest the timing of switching a model in operation to a switch candidate model.

In the example shown in FIG. 8, a time point ts at which the characteristic of the model in operation intersects with the characteristic of the switch candidate model is in the middle between a time point t1 of detecting degradation in the model and time t2. The timing of model switch determination is considered as, for example, (1) the time point ts at which the accuracy equivalent to the model in operation can be secured, (2) the time point t2 at which training of the present context is finished, (3) a time point t3 at which the optimum timing is estimated using domain knowledge, and the like. The optimum timing using the domain knowledge is the timing after learning the context that is predicted to possibly occur in future, for example.

FIG. 9 is a diagram more specifically illustrating the process for updating the model at time t2 in the model switch cost calculation unit 106, showing a graph of costs necessary to update the model calculated by the model switch cost calculation unit 106. As shown in FIG. 9, from the time point t1 at which the model degradation detection unit 104 detects degradation to the update of the model, an erroneous report/false report cost 901t2 of the model in operation occurs. The erroneous report/false report cost of the model in operation is calculated with expression 2 below, for example.

the erroneous report/false report cost of the model in operation per unit time=the number of erroneous reports and false reports per unit time×the occurrence cost per erroneous report and per false report(2M,5M) (expression 2)

At the time of model switch, a cost 902t2 when the model is switched occurs as a fixed cost. The cost when the model is switched is calculated with expression 3 below, for example. However, the cost 902t2 when the model is switched may be calculated by weighting of the erroneous report/false report cost shown in expression 2 and expression 4 regardless of the elements shown in expression 3. The cost when the model is switched may be comprehensively determined using the information and the like of a manufacture management system in addition to the elements shown in expression 3. For example, in the case in which periodical maintenance time is acquired from the manufacture management system acquires and the update of the model is performed at the time of periodical maintenance, it is unnecessary to take into account of temporarily stopping production lines, and thus the cost 902t2 when the model is switched is calculated low.

the cost when the model is switched=the cost of temporarily stopping production lines+the cost of reviewing whether the model is applicable to a production environment+the model creation cost (expression 3)

The erroneous report/false report cost 903t2 of the switch model is calculated from the number of erroneous reports and false reports using the learning curve at time t2. The erroneous report/false report cost of the switch model is calculated with expression 4 below, for example.

the erroneous report/false report cost of the switch model per unit time=the number of erroneous reports and false reports per unit time at time t2×the occurrence cost per erroneous report and per false report(2M,5M) (expression 4)

FIG. 10 is a diagram more specifically illustrating the process for updating the model at time t3 in the model switch cost calculation unit 106, showing a graph of costs necessary to update the model calculated by the model switch cost calculation unit 106. In FIG. 10, an erroneous report/false report cost 901t3 of the model in operation and a cost 902t3 when the model is switched can be similarly calculated as the costs shown in FIG. 9. In the simple case, the cost 902t3 when the model is switched is the same as the cost 902t2 when the model is switched, and can be handled as a fixed value.

Since the model is trained to time t3, an erroneous report/false report cost 903t3 of the switch model is lower in the cost shown in FIG. 9, and the total cost of the update of the model in this case is lower than in FIG. 9.

It can be conceptually understood that the total cost of the update of the model is the area of the hatched parts in FIGS. 9 and 10. As described above, the cost 902 when the model is switched is generally a fixed value, and the erroneous report/false report costs 901 and 903 are a product of a cost per unit time and use time.

As shown in expression 3, when the model in the factory and the plant is switched, an expensive cost 902 when the model is switched occurs. As a result, generally, the number of times of switches is made small as small as possible. As an example, when a decrease in the erroneous report/false report cost due to the update of the model exceeds the model switch cost, this has a meaning of switching the model. As a result, it is assumed that a model that is once switched is used for a long time as long as possible. As an example, it is assumed that a right end tx of a time base shown in FIGS. 9 and 10 expresses a future in the order of a few months to six months. Periods between t1, t2, and t3 express the order of a few days to a few weeks, for example. In the embodiment, it is assumed that at the time of calculating the total cost, the user may specify tx each time. Alternatively, the user may set tx as a fixed value beforehand.

In FIGS. 9 and 10, desirably, the erroneous report/false report cost 903 becomes a constant value, and basically, the model is switched at t3 at which a decrease in the number of erroneous reports and false reports is expected. However, in the case in which there is a possibility of a sudden environmental change or replacement of components or in the case in which the switch model is not fit, for example, there is a possibility that the number of erroneous reports and false reports suddenly increases. In the case in which an expected loss exceeds the cost of switching the model, there is also a possibility that it is better to make a determination is possibly made that the model is switched at t2 in the long run. In this case, in expression 4 above, it is assumed that in the number of erroneous reports and false reports per unit time of the switch model, the value at switch time t2 continues. However, the number of erroneous reports and false reports is predicted by estimating a change in data distribution in future, for example, and thus a more accurate total cost can be calculated.

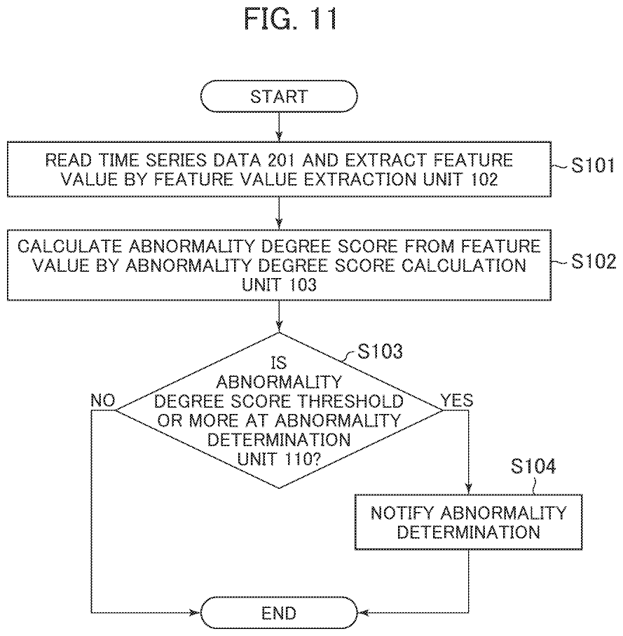

FIG. 11 is a flowchart showing the process procedures of the abnormality diagnosis unit 100. By the procedures in Steps S101 to S104 shown in FIG. 11, the abnormality diagnosis unit 100 performs abnormality diagnosis using the time series data 201 as an input.

In Step S101, from the time series data 201, the feature value extraction unit 102 extracts a feature value used for abnormality diagnosis. The feature value is a value that the feature of an inspection target is digitized, which may be table data, speech data, or image data. In the case of a manufacturing industry-oriented system, the feature value design and the model creation algorithm are unchanged, and a system is assumed in which only the data period used for learning is changed.

In Step S102, the feature value extracted in S101 is input to the abnormality degree score calculation unit 103, and an abnormality degree score is calculated. The abnormality degree score is a value indicating how the measurement value is apart from the center of the normal system of data, for example. The abnormality degree score is calculated with expression 5 below.

(expression 5)

$$ABNORMAL DEGREE SCORE a = \sqrt{{\sum }_{i = 1}^{n} {( MEASUREMENT VALUE - CENTER OF NORMAL SYSTEM )}^{i}} \qquad [ Mathematical formula 1 ]$$

The abnormality degree score may be calculated using the Euclidean distance, Mahalanobis' Distance, Manhattan distance, and any other distance.

In Step S103, the abnormality determination unit 110 performs abnormality determination using the abnormality degree score calculated in S102. In the case in which the abnormality degree score exceeds an abnormality determination threshold, the abnormality determination unit 110 outputs an abnormality, and outputs normality otherwise. The abnormality determination threshold of the abnormality determination unit 110 is decided when the model is created.

In Step S104, in the case in which the abnormality determination unit 110 outputs an abnormality, the user is notified of abnormality determination. The notification may be a GUI, email, or an alert sound presented to the user through the terminal 22.

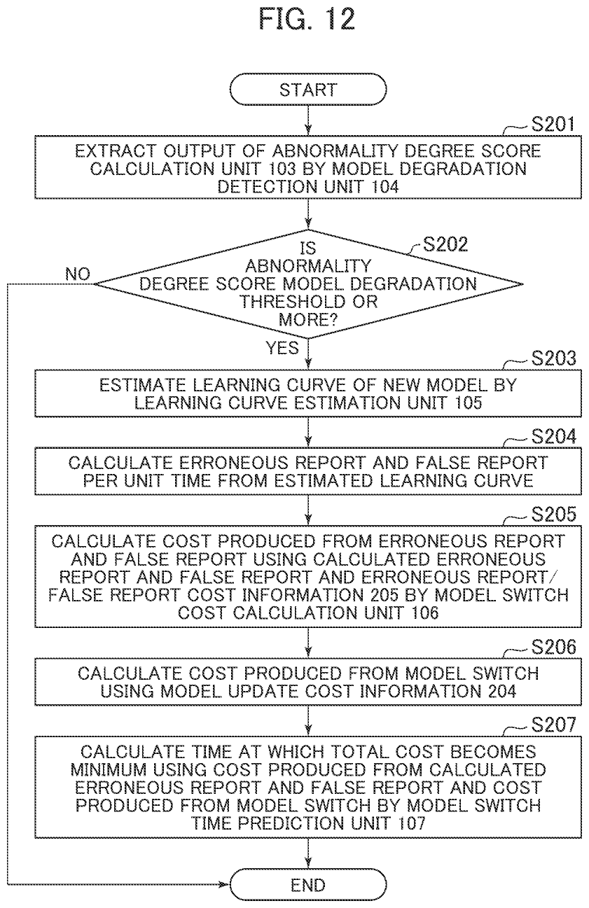

FIG. 12 is a flowchart showing the process procedures of the model update determination unit 101. By the procedures in Steps S201 to S207 shown in FIG. 12, the model update determination unit 101 monitors the model, and performs update determination.

As shown in FIG. 11, an abnormality diagnosis system calculates the abnormality degree score from time series data, and compares the abnormality degree score with the abnormality determination threshold for abnormality diagnosis. The model update determination unit is a system that monitors the state of the abnormality degree score and updates the model when the model is degraded in order to maintain the determination accuracy of the abnormality diagnosis system.

In Step S201, the abnormality degree score calculated by the abnormality degree score calculation unit 103 is extracted. Since the abnormality degree score is a distance from the center of the normal system, in the case in which the abnormality degree score rises, the abnormality degree score shows that the distribution of the data of the time series data 201 is apart from the center of the normal system. In other words, the abnormality degree score shows that the distribution of the time series data changes.

In Step S202, the model degradation detection unit 104 determines whether the abnormality degree score extracted in S201 exceeds the model degradation determination threshold at a plurality of times during a constant period. The model degradation determination threshold is an index calculated when the model is created, and is calculated with an expression below using Hotelling's T-squared method, for example. However, expression 6 below is an expression when the abnormality degree score follows at freedom degree 3 and when the number of pieces of abnormality data is set to 10% of the total.

(expression 6)

∫_{X}^{∞}f(a,3)da=0.10 [Mathematical formula 2]

However, f(a, m) is the probability density function of the chi-squared distribution, a shows the abnormality degree score, and m shows the degree of freedom. In the expression above, X shows the model degradation determination threshold, which can be calculated backward.

The model degradation determination threshold may be determined by a human using domain knowledge and the like.

Since there is also a possibility that the inspection target is continuously false at a plurality of times, in the case in which the abnormality degree exceeds the model degradation determination threshold at a plurality of times during a constant period, this is detected as degradation in the model.

The model degradation state is a state in which a margin distinguishing between normality and abnormality is narrowed, indicating that a risk of the occurrence of the erroneous report and the false report is high. However, the model degradation state indicates that the margin is merely narrowed, neither an erroneous report nor a false report may occur when degradation in the model is detected.

In Step S203, in the case of detecting degradation in the model, the learning curve estimation unit 105 estimates the learning curve of a new model (a switch candidate model in learning in the background). In the case in which a new model created at this time point satisfies the application criteria defined beforehand, the created new model is stored in the model data 206. The application criteria defined beforehand are criteria indicating that the new model satisfies the conditions as a model operating in production, and determination may be made from the data period used for learning, the total volume of data, prediction accuracy, and any other parameter, for example.

In Step S204, the number of erroneous reports and false reports per unit time is calculated using the learning curve estimated in Step S203. For the expression of the number of erroneous reports and false reports, an expression defined by expression 1 is used.

In Step S205, the model switch cost calculation unit 106 calculates the cost produced due to the erroneous report and the false report using the calculated number of erroneous reports and false reports and the erroneous report/false report cost information 204. For the cost produced due to the erroneous report and the false report, an expression defined by expression 2 is used.

In Step S206, the cost produced due to the update of the model is calculated using the model update cost information 203. For the cost produced due to the update of the model, an expression defined by expression 3 is used.

In Step S207, the model switch time prediction unit 107 calculates time at which the total cost becomes the minimum using the cost produced due to the erroneous report and the false report and the cost produced due to the update of the model. The total cost due to the update of the model is calculated with expression 7 below, for example.

the total cost due to the update of the model=the erroneous report/false report cost of the model in operation+the cost when the model is switched+the erroneous report/false report cost of the switch model (expression 7)

The cost produced due to the update of the model is likely to increase or decrease depending on the state of the device or update time; for example, the update of the model at the time when no responsible person is present may produce an approval cost. The cost produced due to the update of the model may be additionally calculated when the total cost is calculated. After the model update time is decided, the user is notified of this. At the model update time, the abnormality diagnosis model creation unit 111 makes a reservation to create a model. The model created by the abnormality diagnosis model creation unit 111 is automatically applied after operation hours of the device, for example. When the model is created, the user may be notified to determine the update of the model.

In the case of Yes in Step S202, i.e., when degradation in the model is detected, through the processes in Steps S203 to S207, the user is notified of the date and time at which degradation is detected, the next scheduled update date and time of the model calculated in Step S207, and the like, for example.

### Second Embodiment

In FIGS. 7 and 8 described above, in prediction of the accuracy of the model, prediction is performed based on the number of pieces of learning data. An example will be described in which learnt context information is further taken into account to intend to improve prediction accuracy.

In this example, a learning curve estimation unit 105 obtains the ratio of context learned by a switch candidate model when a learning curve is estimated, and calculates the learning curve of a switch candidate model based on data indicating the relationship between the ratio of learned context and the number of errors at the time of operation in the machine learning model used in the past.

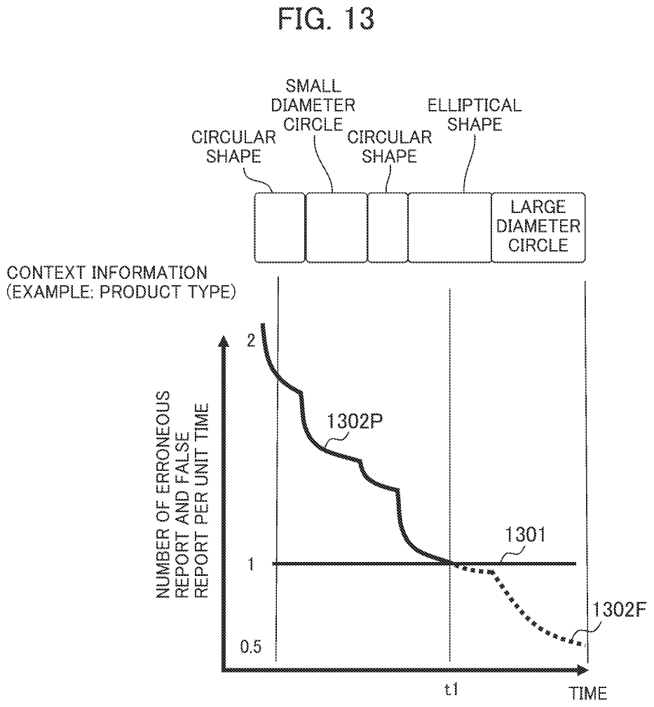

FIG. 13 is an illustration more specifically describing a method of supposing a learning curve using context information. The context information is information indicating a change in the state of a facility, a material, method, person, environment, and the like, including a change in the product type, for example. The context information will be described in more detail with reference to FIG. 14. In the embodiment in FIG. 13, the learning curve is estimated from the ratio of learned context of the model in the past and the number of erroneous reports and false reports per unit time.

In FIG. 13, the numerical characters “2”, “1”, and “0.5” in the drawing express the number of erroneous reports and false reports per unit time on the vertical axis, showing that with a lapse of time shown on the horizontal axis, learning progresses and the number of erroneous reports and false reports per unit time decreases.

A solid line 1301 in parallel with the horizontal axis expresses the characteristic of a model in operation. In this example, in a model presently in operation, one of the number of erroneous reports and false reports occurs per unit time. A solid line 1302P is the characteristic of a switch candidate model, expressing the number of erroneous reports and false reports of a trained model. A broken line 1302F is the characteristic of the switch candidate model, and is a prediction value of the number of erroneous reports and false reports of a trained model in future.

It is assumed that a target is a fabrication apparatus for an optical cable, the cross sectional shape of an optical cable to be fabricated has types of “a circular shape”, “a small diameter circle”, “an elliptical shape”, and “a large diameter circle”, and these are defined as context information. FIG. 13 shows changes in the type of cable being fabricated over time.

As shown by the characteristic of the solid line 1302P, as a result of learning the context of a circular shape, a small diameter circle, an elliptical shape, and any other shape by the switch candidate model, the switch candidate model achieves the number of erroneous reports and false reports equal to the model in operation expressed by the solid line 1301 at a time point of time t1. However, an on-site engineer can know that the context of a large diameter circle is not trained yet from domain knowledge (e.g., fabrication actual results in the past and fabrication schedules in future). As a result, determination can be made in which switching the model after the context of a large diameter circle is trained provides higher accuracy.

FIG. 14 is an illustration describing context information in detail. The context information is information on changes in a facility, a material, a method, a person, an environment, and any other parameters, corresponding to a product type, for example. FIG. 14 presents an example of device context information on fabricating a product that is a cable.

In the case in which the product type is a cable, quality to be obtained and specifications are varied depending on the type of cable. The characteristic of deciding quality includes elongation, tensile strength, flame resistance, and any other parameters. Since these characteristics change due to manufacture parameters in the manufacturing process steps, as the context information, a combination of a product type and a process step is thought. Therefore, even though the manufacturing process steps are constant, there is possibility that the context increases due to an increase in the product type.

FIG. 15 is a flowchart showing the process procedures of the learning curve estimation unit 105 using the context information. By the procedures in Steps S301 to S304 shown in FIG. 15, the learning curve is estimated using the context information.

In Step S301, context information is acquired from context information 202. The context information may be acquired from a manufacture management system, event logs, maintenance records, and the like.

In Step S302, in the total number of contexts, the ratio of learned contexts (product types) is calculated. For example, in the case in which the existence probability of the context is biased due to the bias of the manufactured product of the target device, and the like, the ratio of learned context may be weighted.

In Step S303, the ratio of the learned context (the product type) is compared with the number of erroneous reports and false reports of the past model after operated.

In Step S304, the learning curve of a switch candidate model is estimated using the model in the closest state compared in Step S303.

one of the learning curve estimation based on the number of pieces of learning data according to the first embodiment and the learning curve estimation based on the number of contexts according to the second embodiment may be used, or both estimation results are weighted and used as estimation results.

### Third Embodiment

In the following, a third embodiment will be described with reference to the drawings.

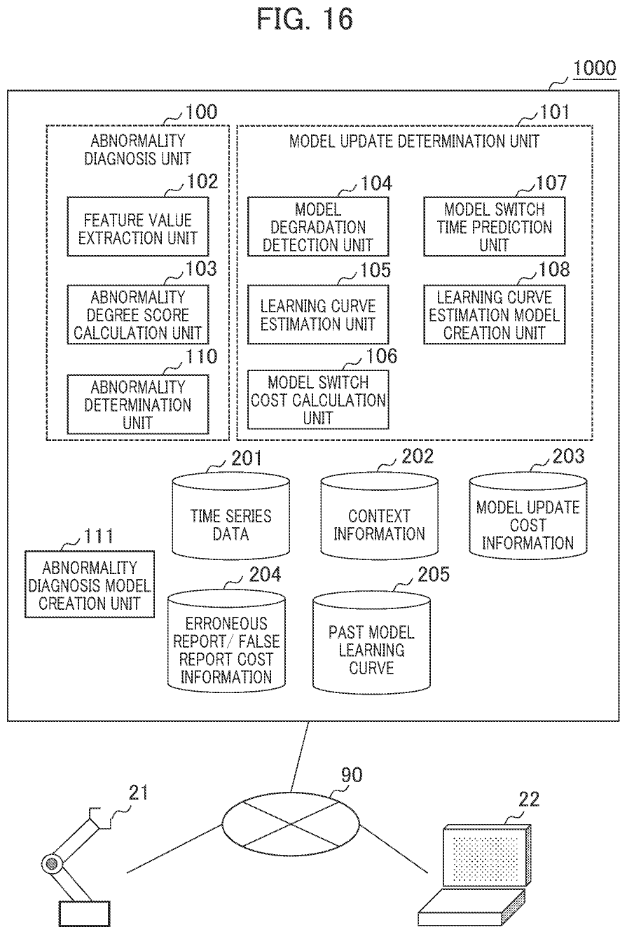

FIG. 16 is an illustration describing the third embodiment using a past model learning curve more in detail. In the third embodiment, a learning curve estimation model is created using a past model learning curve. In comparison with the example shown in FIG. 1, a learning curve estimation model creation unit 108 and (data of) a past model learning curve 205 are included.

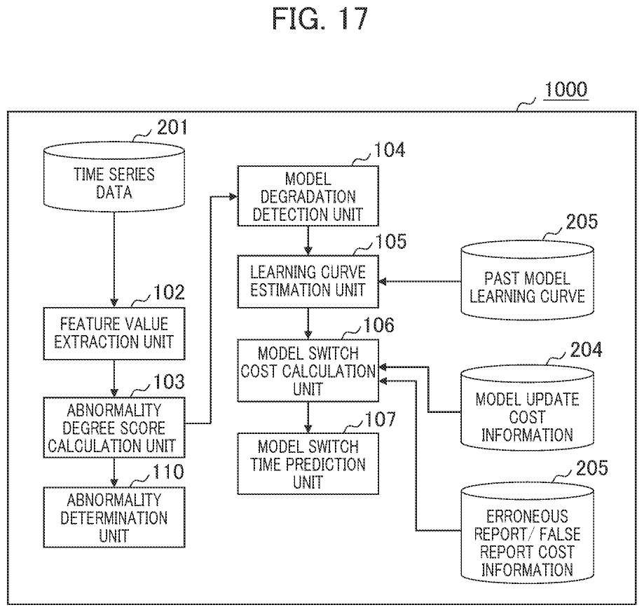

FIG. 17 is a functional block diagram showing the input-output relationship of information between modules. The functions are implemented by performing a program by a processor as shown in FIG. 17.

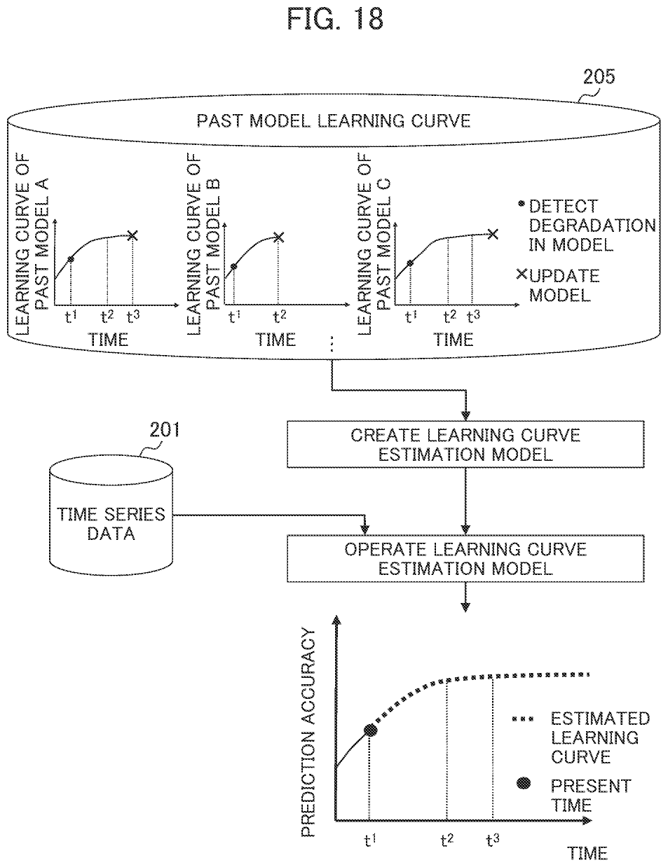

FIG. 18 is an illustration describing the process of learning curve estimation using a past model learning curve in detail. In the case in which the algorithm of the model does not change and a target device is the same, learning curves have a similar shape, and thus machine learning, statistical modeling, and the like are applicable.

As shown in FIG. 18, a model that estimates a future learning curve is created from a past model learning curve 205. For creating a learning curve estimation model, methods such as machine learning and statistical modeling may be used. The created learning curve estimation model is incorporated in a learning curve estimation unit 105, and estimates a learning curve with an input of time series data 201.

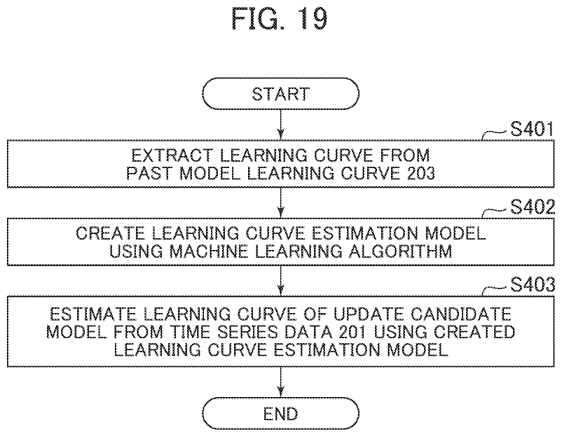

FIG. 19 is a flowchart showing the process procedures of the learning curve estimation unit 105 using the past model learning curve. By the procedures in Steps S401 to S403 shown in FIG. 19, the learning curve is estimated using the past model learning curve.

In Step S401, a learning curve when a past model is created is extracted from the past model learning curve 205. In regard to the learning curve to be extracted, the improvement of the accuracy of a learning curve estimation model in the subsequent stage may be intended by setting extraction conditions such as a specific period, actual operation result of the past model.

In Step S402, using the learning curve when the past model is created extracted in Step S401, a learning curve estimation model is created for creating a learning curve estimation model. For the learning curve estimation model, methods including statistical modeling and a neural network, for example, may be used.

In Step S403, using the learning curve estimation model, the learning curve of the update candidate model is estimated from the time series data 201. In addition to a result estimated by a learning curve estimation model movable part 109, the learning curve may be estimated from a plurality of estimation results using the learning curve estimated from context information and the like using the learning curve estimation unit 105.

According to the foregoing embodiments, in regard to the operation of the machine learning model, a client can know whether the cost of the update of the model can be decreased when the client makes a determination to update the model, and thus it is possible to assist determination of the model update time.

What is claimed is:

1. A computer system that detects an abnormality based on time series data, the system comprising:
an abnormality diagnosis unit that diagnoses an abnormality of the time series data from a machine learning model created based on learning data;
a model degradation detection unit that detects degradation in the machine learning model;
a learning curve estimation unit that estimates a learning curve of the machine learning model and predicts a number of errors per unit time using the learning curve;
a model switch cost calculation unit that calculates a number of errors per the unit time of a model in operation that is a machine learning model presently being used, a number of errors per the unit time of a switch candidate model that is a switch candidate of a model in operation, a first total cost when a machine learning model is switched at given first time based on error cost information that defines a cost per error, and a second total cost when a machine learning model is switched at given second time; and
a model switch time prediction unit that compares the first total cost with the second total cost to calculate switch time of a machine learning model.

2. The computer system according to claim 1,
wherein: the learning curve estimation unit obtains a number of samples of data learnt by the switch candidate model when a learning curve is estimated; and
the learning curve estimation unit calculates a learning curve of the switch candidate model based on data indicating a relationship between a number of samples of learnt data in a machine learning model and a number of errors at time of operation used in past.

3. The computer system according to claim 1,
wherein: the learning curve estimation unit obtains a ratio of context learned by the switch candidate model when a learning curve is estimated; and
the learning curve estimation unit calculates a learning curve of the switch candidate model based on data indicating a relationship between ratio of learned context and number of errors at time of operation in machine learning model used in past.

4. The computer system according to claim 1,
wherein the learning curve estimation unit calculates a learning curve of the switch candidate model using a learning curve estimation model created from a learning curve when a model is created in past when a learning curve is estimated.

5. The computer system according to claim 1,
wherein the model degradation detection unit detects a change in a distribution of the time series data.

6. The computer system according to claim 1,
wherein the model switch cost calculation unit further calculates the first total cost and the second total cost based on a model update cost necessary to switch the machine learning model.

7. The computer system according to claim 6,
wherein the model update cost is a fixed value, and assuming that the machine learning model is switched between time t1 and time tx between which is a predetermined duration, the first total cost and the second total cost are calculated.

8. The computer system according to claim 7,
wherein: the time t1 is time based on time at which the model degradation detection unit detects degradation in the machine learning model; and
the time tx is time specified by a user.

9. The computer system according to claim 8,
wherein upon receiving a result of the model switch cost calculation unit, the model switch time prediction unit predicts time T at which the machine learning model is switchable at a minimum total cost.

10. A method of determining model switch timing comprising:
in a computer system that diagnoses an abnormality of time series data from a machine learning model created based on learning data, when timing of switching of the machine learning model is determined,
a model degradation detecting step of detecting degradation in the machine learning model;
a learning curve estimation step of estimating a learning curve of the machine learning model to predict a number of errors per unit time using the learning curve;
a model switch cost calculating step of calculating a number of errors per the unit time of a model in operation that is a machine learning model presently being used, a number of errors per the unit time of a switch candidate model that is a switch candidate of a model in operation, a first total cost when a machine learning model is switched at given first time based on error cost information that defines a cost per error, and a second total cost when a machine learning model is switched at given second time; and
a model switch time predicting step of comparing the first total cost with the second total cost to calculate switch time of a machine learning model.

11. The method of determining model switch timing according to claim 10,
wherein in the learning curve estimation step, a learning curve of the switch candidate model is calculated based on at least one of first past data indicating a relationship between a number of samples of learnt data and a number of errors at time of operation in a machine learning model used in past and second past data indicating a relationship between a ratio of learned context and a number of errors at time of operation in a machine learning model used in past.

12. The method of determining model switch timing according to claim 11,
wherein in the learning curve estimation step, a learning curve of the switch candidate model is calculated using a learning curve estimation model created from a learning curve when a model is created in past when a learning curve is estimated.

13. The method of determining model switch timing according to claim 10,
wherein in the model switch cost calculating step, the first total cost and the second total cost are further calculated based on a model update cost necessary to switch the machine learning model.

14. The method of determining model switch timing according to claim 13,
wherein the model update cost is a fixed value, and assuming that the machine learning model is switched between time t1 and time tx between which is a predetermined duration, the first total cost and the second total cost are calculated.

15. The method of determining model switch timing according to claim 14,
wherein: the time t1 is time based on time at which degradation in the machine learning model is detected in the model degradation detecting step; and
the time tx is time specified by a user.
